(19) United States
(12) Patent Application Publication
(10) Pub. No.: US 2022/0348087 A1
(43) Pub. Date: Nov. 3, 2022

(54) PREVENTING UNWANTED TRAILER MOVEMENT

(71) Applicant: Toyota Motor Engineering & Manufacturing North America, Inc., Plano, TX (US)

(72) Inventor: Takehito Yokoo, Aliso Viejo, CA (US)

(21) Appl. No.: 17/243,881

(22) Filed: Apr. 29, 2021

(51) Int. Cl. B60L 7/18; B60T 8/17; B60T 13/26

(52) U.S. Cl. CPC B60L 7/18; B60T 8/1708; B60T 13/26; B60T 2220/04; B60L 2200/28

(57) ABSTRACT

Braking of a vehicle and a trailer can be balanced when regenerative braking of the vehicle is activated. The activation of regenerative braking of the vehicle can be detected. Responsive to detecting that regenerative braking of the vehicle is activated, one or more brakes of the trailer can be caused to be activated. Thus, the braking effectiveness of the vehicle and the braking effectiveness of the trailer can be substantially balanced. As a result, a possible push force from a trailer to the vehicle towing the trailer can be reduced, which, in turn, can help to avoid unwanted movements of the trailer (e.g., swaying or jackknifing).

### FIELD

The subject matter described herein relates in general to vehicles and, more particularly, to vehicles towing a trailer.

### BACKGROUND

A trailer is typically an unpowered vehicle that is towed by a powered vehicle. The trailer is mechanically coupled to the powered vehicle. Trailers can provide additional cargo space for a vehicle, such as for transporting goods, equipment, and materials.

### SUMMARY

In one respect, the present disclosure is directed to a method of balanced braking for a vehicle and a trailer. The method can include detecting whether regenerative braking of the vehicle is activated. Responsive to detecting that regenerative braking of the vehicle is activated, the method can further include causing one or more brakes of the trailer to be activated.

In another respect, the present disclosure is directed to a system of balanced braking for a vehicle and a trailer. The system includes one or more processors. The one or more processors can be programmed to initiate executable operations. The executable operations can include detecting whether regenerative braking of the vehicle is activated. Responsive to detecting that regenerative braking of the vehicle is activated, the executable operations can include causing one or more brakes of the trailer to be activated.

### BRIEF DESCRIPTION OF THE DRAWINGS

FIG. 1 is an example of a vehicle pulling a trailer.

FIG. 2 is an example of the vehicle.

FIG. 3 is an example of the trailer.

FIG. 4 is a method for balanced braking for the vehicle and the trailer.

### DETAILED DESCRIPTION

When a powered vehicle is towing a trailer, there are several instances in which undesired or unwanted trailer movement can occur. For example, in some situations, a braking effectiveness differential between the vehicle and the trailer can occur. For instance, when regenerative braking is applied, regenerative braking torque is only applied to the wheels of the vehicle, but braking torque is not applied to the wheels of the trailer. As a result, there is an imbalance in the braking torque between the vehicle and the trailer. However, due to the mechanical connection between the vehicle and the trailer, the trailer may move in an unwanted way, such as by swaying or jackknifing, because of the braking torque imbalance.

Accordingly, arrangements described herein are directed to preventing unwanted trailer movements. More particularly, arrangements described herein are directed to preventing unwanted trailer movements during regenerative braking. Arrangements described herein can include detecting whether regenerative braking of the vehicle is activated. Responsive to detecting that regenerative braking of the vehicle is activated, one or more brakes of the trailer can be caused to be activated. Thus, by balancing the braking torque between the vehicle and the trailer, unwanted trailer movements can be reduced or prevented.

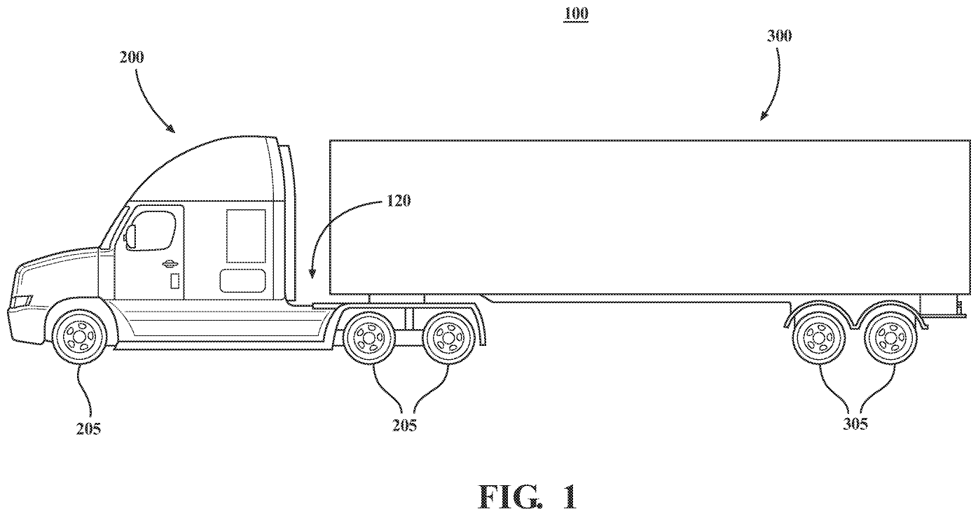

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a system 100 including a vehicle 200 and a trailer 300 are shown. The vehicle 200 can be operatively connected to the trailer 300 in one or more ways. The term “operatively connected,” as used throughout this description, can include direct or indirect connections, including connections without direct physical contact. For instance, there can be one or more connections 150 between the vehicle 200 and the trailer 300.

The vehicle 200 and the trailer 300 can be operatively connected to each other in any suitable manner to keep them together while in motion. The trailer 300 can be operatively connected to the vehicle 200 in any suitable mechanical manner, now known or later developed. One non-limiting example of a mechanical connection can be any suitable type of hitch, now known or later developed. However, it will be appreciated that numerous other forms of additional or alternative mechanical couplings can be provided.

Further, the vehicle 200 can include one or more output lines 120. The trailer 300 can be operatively connected to the output line(s) 120. For example, one of the output lines 120 can be an electrical output line. Thus, the trailer 300 can be operatively connected to the vehicle 200 in an electrical manner, using any suitable form of electrical connection, now known or later developed. The electrical connection between the vehicle 200 and the trailer 300 can enable brake lights and/or turn signals of the trailer 300 to be activated based on the activation of the brake lights and/or turn signals of the vehicle 200.

As another example, one of the output lines 120 can be an air output line. Thus, the trailer 300 can be operatively connected to the air output line of the vehicle 200 using any suitable form of connection, now known or later developed. The air connection between the vehicle and the trailer 300 can enable air from a source on the vehicle 200 to be used to activate one or more brakes of the trailer 300.

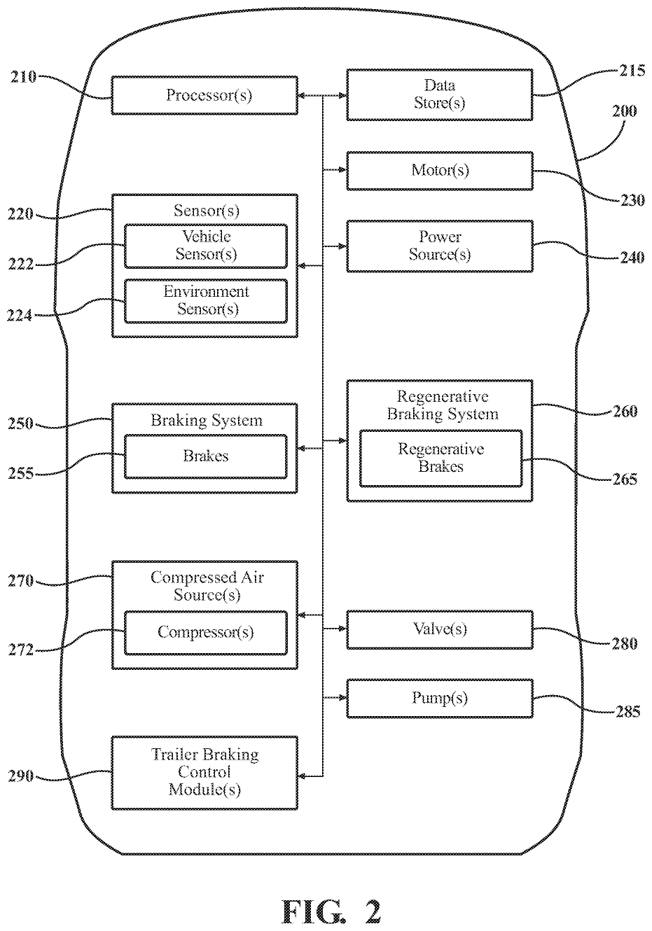

Referring to FIG. 2, an example the vehicle 200 is shown. The vehicle 200 can be any vehicle that is powered and that is configured for regenerative braking. The vehicle 200 can be configured to tow, pull, or haul a trailer. Non-limiting examples of the vehicle 200 can include an automobile, a semi-trailer truck, a tractor-trailer, a truck, a pick-up truck, a sports utility vehicle, a van, a minivan, or a car.

In one or more arrangements, the vehicle 200 can be an electric vehicle (EV), a hybrid electric vehicle (HEV), or a fuel cell vehicle (FCV). In one or more arrangements, the vehicle 200 can be a fully electric vehicle, a primarily electric vehicle, or a hybrid electric vehicle. The vehicle 200 can include one or more engines, one or more electric motors, and/or one or more batteries.

In some arrangements, the vehicle 200 can be an autonomous vehicle in which one or more computing systems are used to navigate and/or maneuver the vehicle along a travel route with minimal or no input from a human driver. In one or more arrangements, the vehicle 200 can be highly automated or completely automated. The vehicle 200 can be semi-autonomous vehicle in which a portion of the navigation and/or maneuvering of the vehicle along a travel route is performed by one or more computing systems, and a portion of the navigation and/or maneuvering of the vehicle along a travel route is performed by a human driver. The vehicle 200 can be a manual vehicle in which all of or a majority of the navigation and/or maneuvering of the vehicle is performed by a human driver.

The vehicle 200 can include various elements. Some of the possible elements of the vehicle 200 are shown in FIG. 2 and will now be described. However, it will be understood that it is not necessary for the vehicle 200 to have all of the elements shown in FIG. 2 or described herein. The vehicle 200 can have any combination of the various elements shown in FIG. 2. Further, the vehicle 200 can have additional elements to those shown in FIG. 2. In some arrangements, the vehicle 200 may not include one or more of the elements shown in FIG. 2. Further, the elements shown may be physically separated by large distances. In some arrangements, one or more of the elements shown in FIG. 2 may be located onboard the vehicle 200, the trailer 300, or in a remote location.

The vehicle 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, relay logic, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

The vehicle 200 can include one or more data stores 215 for storing one or more types of data. The data store(s) 215 can include volatile and/or non-volatile memory. Examples of suitable data stores 215 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 215 can be a component of the processor(s) 210, or the data store(s) 215 can be operatively connected to the processor(s) 210 for use thereby.

As noted above, the vehicle 200 can include one or more sensors 220. “Sensor” means any device, component and/or system that can detect, determine, assess, monitor, measure, quantify and/or sense something. The sensor(s) 220 can detect, determine, assess, monitor, measure, quantify and/or sense in real-time. The term “real-time,” as used herein, can mean a level of processing responsiveness that a user or system senses as sufficiently immediate for a particular process or determination to be made, or that enables the processor to keep up with some external process. The sensor(s) 220 can be operatively connected to the processor(s) 210, the data store(s) 215, and/or other element of the vehicle 200 (including any of the elements shown in FIG. 2).

The sensor(s) 220 can include any suitable type of sensor. Various examples of different types of sensors will be described herein. However, it will be understood that the embodiments are not limited to the particular sensors described.

The sensor(s) 220 can include one or more vehicle sensors 222. The vehicle sensor(s) 222 can acquire, capture, detect, determine, assess, monitor, measure, quantify, and/or sense information or data about the vehicle 200 itself (e.g., position, orientation, speed, acceleration, deceleration, direction, accelerator pedal position, brake pedal position, pedal position, steering wheel position, etc.) and changes thereto. The vehicle sensor(s) 222 can be any sensor, now known or later developed. In one or more arrangements, the one or more vehicle sensors 222 can include various inertial sensors such as gyroscopes and accelerometers, speedometers, vehicle wheel speed sensors, road condition sensors, suspension height sensors, steering angle sensors, steering torque sensors, brake pedal pressure sensors, brake position sensors, accelerator pedal pressure sensors, accelerator pedal position sensors, and/or tire pressure sensors, just to name a few possibilities. The vehicle sensor(s) 222 can include one or more brake-related sensors, such as a regenerative braking torque sensors. The regenerative braking torque sensors can acquire, capture, detect, determine, assess, monitor, measure, quantify, and/or sense information or data about regenerative braking torque of the vehicle 200. In some arrangements, regenerative braking torque sensors can determine the regenerative braking torque, or they can acquire data from which regenerative braking torque can be determined.

The sensor(s) 220 can include one or more environment sensors 224 configured to acquire, detect, determine, assess, monitor, measure, quantify, and/or sense data or information about the external environment in which a vehicle is located or one or more portions thereof. The environment sensor(s) 224 can be any sensor, now known or later developed. Non-limiting examples of environment sensors 224 include one or more radar sensors, one or more LIDAR sensors, one or more sonar sensors, and/or one or more cameras.

The vehicle 200 can include wheels 205 (FIG. 1), one or more motors 230, and one or more pedals. The wheels 205 can be configured to support the vehicle 200 and/or to facilitate movement of the vehicle 200. The wheels 205 can be any kind of wheel, now know or later developed. The motor(s) 230 can be operatively connected to the wheels 205. The motor(s) 230 can be configured to propel or slow the wheels 205. The pedal(s) can include a brake pedal and an accelerator pedal. In some arrangements, the vehicle 200 can be configured for one pedal driving.

The vehicle 200 can include one or more power sources 240. The power source(s) 240 can be any power source capable of and/or configured to power the vehicle 10 and/or one or more elements thereof, such as the motor(s) 230. For example, the power source(s) 240 can include one or more engines, one or more batteries, one or more fuel cells, one or more generators, one or more alternators, one or more solar cells, and combinations thereof.

The vehicle 200 can include a braking system 250. The braking system 250 can include one or more mechanisms, devices, elements, components, systems, and/or combinations thereof, now known or later developed, configured to decelerate the vehicle 200. As an example, the braking system 250 can be a friction braking system, an air braking system, or a mechanical braking system. The braking system 250 can include a plurality of brakes 255. Each brake 255 can be operatively connected to one of the wheels 205. The brakes 255 can include any systems, components, apparatus, etc. of any type of brake, now known or later developed. For example, when the brakes 255 are friction brakes, each brake 255 can include a brake disk, a brake caliper, and a brake pad. Each brake 255 can be operatively connected to the brake pedal so as to be responsive thereto. Thus, when an operator of the vehicle 200 engages the brake pedal, the brake caliper can compress, causing the brake pad to contact the brake disk, thereby slowing the wheel 205.

The vehicle 200 can also include a regenerative braking system 260. The regenerative braking system 260 can include one or more regenerative brakes 265. The regenerative brakes 265 can include any systems, components, apparatus, etc. of any type of regenerative braking system, now known or later developed. For example, the regenerative brakes 265 can include the wheels 205, the motor(s) 230, and the power source(s) 240. The regenerative braking system 260 can also include one or more inverters. When an operator of the vehicle 200 disengages the accelerator pedal or engages the brake pedal, the inverter(s) can be configured to cause the magnetic field generated in coil(s) of the motor(s) 230 to be deactivated. As a result, the motor(s) 230 no longer drive the wheels 205. Instead, the motor(s) 230 are driven by the rotation of the wheels 205. Thus, the motor(s) 230 can begin to act as a generator, generating electrical energy. As such, the motor(s) 230 can be configured to supply generated energy to the batteries and/or the power sources 240. The wheels 205 are then slowed by friction acting between the wheels 205 and the road, thereby slowing the vehicle 10.

The regenerative braking system 260 can include profiles and logic for adjusting the amount of regenerative braking torque. To adjust the amount of regenerative braking torque, the regenerative braking system 260 can be configured to control the amount of energy supplied from the motor(s) 230 to the batteries and/or power sources 240. The amount of energy supplied can be controlled by the inverter(s). The amount of energy supplied from the motor(s) 230 to the batteries and/or power sources 240 affects the amount of regenerative braking torque. For example, when the regenerative braking system 260 determines that the amount of regenerative braking torque should be increased, the regenerative braking system 260 can be configured to increase the amount of energy supplied from the motor(s) 230 to the batteries and/or power source(s) 240. In another example, when the regenerative braking system 260 determines that the amount of regenerative braking should be decreased, the regenerative braking system 260 can be configured to decrease the amount of energy supplied from the motor(s) 230 to the batteries and/or power source(s) 240.

The vehicle 200 can include one or more compressed air sources 270. The compressed air source(s) 270 can be located onboard the vehicle 200. The compressed air source(s) 270 can include, for example, a compressor 272. In some arrangements, the compressed air source(s) 270 can be operatively connected to one or more components of the trailer 300 via a conduit 320. For instance, the conduit 320 can be in fluid communication to supply compressed air from the compressed air source(s) 270 to a braking system 310 of the trailer 300. In some arrangements, the conduit 320 can be operatively connected to one of the output lines 120 (e.g., the air output line) of the vehicle 200.

In some arrangements, the vehicle 200 can include one or more valves 280. The valve(s) 280 can be controlled to be selectively opened and closed. The valve(s) 2680 can be operatively positioned along the conduit 320 and/or the air output line to control the supply compressed air from the compressed air source(s) 270 to the braking system 310 (or one or more components thereof) of the trailer 300. The valve(s) 280 can be any suitable type of valve, now known or later developed. As an example, the valve(s) 280 can be a solenoid valve.

In some arrangements, the vehicle 200 can include one or more pumps 285. The pump(s) 285 can be operatively connected to facilitate the supply of compressed air from the compressed air source(s) 270 to the braking system 310 (or one or more components thereof) of the trailer 300. In some arrangements, the pump(s) 285 can be operatively positioned along the conduit 320 and/or the air output line. The pump(s) 285 can be any suitable type of pump, now known or later developed.

The vehicle 200 can include one or more modules. The modules can be implemented as computer readable program code that, when executed by a processor, implement one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 215 may contain such instructions. The modules described herein can include artificial or computational intelligence elements, e.g., neural network, fuzzy logic or other machine learning algorithms. Further, the modules can be distributed among a plurality of modules.

The vehicle 200 can include one or more trailer braking control modules 290. The trailer braking control module(s) 290 can be configured to analyze data or information acquired by one or more of the sensor(s) 220. Alternatively or additionally, the trailer braking control module(s) 290 can be configured to detect user inputs (e.g., commands) provided on the input interface(s) in the vehicle 200. The trailer braking control module(s) 290 can retrieve raw data from the sensor(s) and/or from the data store(s). The trailer braking control module(s) 290 can use profiles, parameters, or setting loaded into the trailer braking control module(s) 290 and/or stored in the data store(s). The trailer braking control module(s) 290 can analyze the sensor data to determine appropriate actions.

The trailer braking control module(s) 290 can be configured to detect whether regenerative braking of the vehicle 200 is activated. The trailer braking control module(s) 290 can be configured to do so in any suitable manner. As an example, the trailer braking control module(s) 290 can be configured to directly detect whether regenerative braking of the vehicle is activated. Such detection can be performed by communication with the regenerative braking system 36. For instance, the regenerative braking system 36 can send a signal to the trailer braking control module(s) 290 that the regenerative braking is activated. In some arrangements, the detection can be performed by receiving an input or command from a user (e.g., an occupant of the vehicle 200).

As another example, the trailer braking control module(s) 290 can be configured to detect whether that driver is or is not engaging an accelerator pedal of the vehicle, such as by using sensor data from one or more of the sensors 220 (e.g., accelerator pedal pressure sensor, accelerator pedal position sensor, speedometer, accelerometer, etc.). If the trailer braking control module(s) 290 detects that the accelerator pedal is not being engaged, then the trailer braking control module(s) 290 can be configured to determine that regenerative braking of the vehicle 200 is activated.

As still another example, the trailer braking control module(s) 290 can detect whether regenerative braking torque is being applied to one or more wheels 205 of the vehicle 200. Such detection can be performed by communication with the regenerative braking system 36 and/or by sensor data from the sensor(s) 220. The trailer braking control module(s) 290 can be configured to analyze such data to detect whether regenerative braking is activated. The trailer braking control module(s) 290 can be configured to detect an amount of regenerative braking torque applied to the one or more wheels 205 of the vehicle 200. The trailer braking control module(s) 290 can also be configured to detect an amount of braking torque applied to the one or more wheels 205 of the vehicle 200 by the braking system 250.

If the trailer braking control module(s) 290 detects that the regenerative braking of vehicle is not activated, then the trailer braking control module(s) 290 can take no action. However, if the trailer braking control module(s) 290 detects that the regenerative braking of the vehicle 200 is activated, the trailer braking control module(s) 290 can be configured to cause one or more brakes of the trailer to be activated. In some arrangements, the trailer braking control module(s) 290 can be configured to cause the one or more brakes of the trailer to be activated in an amount corresponding to an amount of regenerative braking of the vehicle. In some arrangements, the trailer braking control module(s) 290 can be configured to cause one or more brakes of the trailer to be activated in an amount corresponding to the amount of regenerative braking torque applied to the one or more wheels 205 of the vehicle 200. In this way, the trailer braking control module(s) 290 can be configured to substantially balance the braking torque applied to one or more brakes of the vehicle 200 and the braking torque applied to one or more brakes of the trailer 300.

The trailer braking control module(s) 290 can be configured to cause the one or more brakes of the trailer to be activated in any suitable manner. As used herein, “cause” or “causing” means to make, force, compel, direct, command, instruct, and/or enable an event or action to occur or at least be in a state where such event or action may occur, either in a direct or indirect manner. For instance, the trailer braking control module(s) 290 can selectively permit or prevent the flow of compressed air from the compressed air source(s) 270 to the braking system 310 (or one or more components thereof) of the trailer 300.

For instance, the trailer braking control module(s) 290 can be configured to cause a valve to be opened to allow compressed air from the vehicle to be supplied to the one or more brakes of the trailer. In some arrangements, the trailer braking control module(s) 290 can be configured to control the degree to which the valve is opened, thereby regulating the amount of compressed air that can be supplied from the compressed air source. In some arrangements, the trailer braking control module(s) 290 can be configured to control the compressed air source to change the pressure of the compressed air. In some arrangements, the trailer braking control module(s) 290 can be configured to control the pump(s) 285 to facilitate movement of the compressed air to a destination (e.g., one or more brakes of the trailer). The trailer braking control module(s) 290 can be configured send control signals or commands over a communication network to the valve(s) 280, the pump(s) 285, and/or other elements of the vehicle 200 or the trailer 300.

The trailer braking control module(s) 290 can be configured to monitor the state of the regenerative braking of the vehicle 200. The trailer braking control module(s) 290 can be configured to do so continuously, periodically, irregularly, randomly, or in response to a user input or command.

The trailer braking control module(s) 290 can be configured to detect whether regenerative braking of the vehicle 200 is deactivated. The trailer braking control module(s) 290 can be configured to do so in any suitable manner. The trailer braking control module(s) 290 can be configured to cause the one or more brakes of the trailer to be deactivated in any suitable manner, such as by causing the valve to be closed.

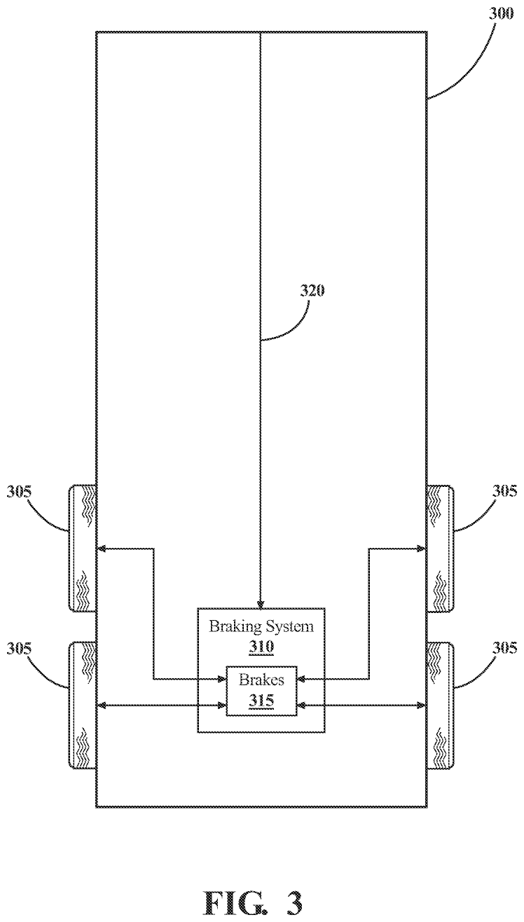

Referring to FIG. 3, an example of a trailer 300 is shown. The trailer can be a non-powered vehicle. A trailer can be configured to be towed, pulled, and/or hauled by a powered vehicle. The trailer 300 can be used for various purposes, such as to store and/or transport various items, goods, materials, and/or things. Non-limiting examples of the trailer 300 include a full-trailer, a semi-trailer, a horse trailer, a livestock trailer, a flatbed trailer, a travel trailer, and a boat trailer. The trailer 300 can be any type of trailer, now known or later developed. The trailer 300 can be a semi-passive form of transport in that the trailer 300 may include components or groups of components that can facilitate it being towed, pulled, and/or hauled by another powered vehicle, but the trailer 300 may not be independently operated as a vehicle.

The trailer 300 can include various elements. Some of the possible elements of the trailer 300 are shown in FIG. 3 and will now be described. However, it will be understood that it is not necessary for the trailer 300 to have all of the elements shown in FIG. 3 or described herein. The trailer 300 can have any combination of the various elements shown in FIG. 3. Further, the trailer 300 can have additional elements to those shown in FIG. 3. In some arrangements, the trailer 300 may not include one or more of the elements shown in FIG. 3. Further, the elements shown may be physically separated by large distances.

The trailer 300 can include wheels 305. The wheels 305 can be configured to support the trailer 300 and to facilitate its movement. The wheels 305 can be any kind of wheel, now know or later developed. The wheels 305 can be passive wheels in that they are not powered wheels.

The trailer 300 can include a braking system 310. In one or more arrangements, the braking system 310 can be a friction braking system. The braking system 310 can include a plurality of brakes 315. Each brake 315 can be operatively connected to one of the wheels 305. The brakes 315 can include any systems, components, apparatus, etc. of any type of braking system, now known or later developed. For example, when the braking system 310 is a friction braking system, each brake 315 can include a brake disk, a brake caliper, and a brake pad. Each brake 315 can be operatively connected to the brake pedal.

In some arrangements, the brakes 315 can be configured to be activated by air. For instance, the brakes 315 can be activated based on the supply of compressed air from the compressed air source(s) 270. Thus, when compressed air is supplied to the brakes 315, the brake caliper can compress, causing the brake pad to contact the brake disk, thereby slowing the wheel 305. The degree of braking and the amount of braking torque applied to the wheels 305 can be directly related to amount, pressure, and/or duration of compressed air supplied by the compressed air source(s) 270.

In some arrangements, the trailer 300 can include one or more trailer sensors. The trailer sensor(s) can include one or more brake-related sensors, such as one or more braking torque sensors. The braking torque sensors can acquire, capture, detect, determine, assess, monitor, measure, quantify, and/or sense information or data about braking torque applied to one or more of the wheels 305 of the trailer 300. In some arrangements, the braking torque sensors can determine the amount braking torque applied to one or more of the wheels of the trailer 300. Alternatively or additionally, in some arrangements, the braking torque sensors can acquire data from which braking torque can be determined.

In some arrangements, the braking torque sensors can be communicatively linked to the processor(s) and/or the trailer braking control module(s) 290. The processor(s) and/or the trailer braking control module(s) 290 can be configured to compare the braking torque applied to one or more of the wheels of the trailer 300 and the regenerative braking torque applied to one or more wheels of the vehicle 200. The processor(s) and/or the trailer braking control module(s) 290 can be configured to adjust the amount of braking torque applied to one or more wheels of the trailer 300 so as to be substantially balanced with the braking torque applied to one or more wheels of the vehicle 200.

In some arrangements, one or more elements shown in connection with the vehicle 200 can be located on the trailer 300. As an example, the compressed air source(s) 270, the valve(s) 280, and/or the pump(s) 285 can be located on the trailer 300.

Further, the various elements of the vehicle 200 can be communicatively linked to each other through one or more communication networks. Further, one or more elements of the vehicle 200 can be communicatively linked to the trailer 300 and/or one or more elements of the trailer 300 through one or more communication networks. As used herein, the term “communicatively linked” can include direct or indirect connections through a communication channel or pathway or another component or system. A “communication network” means one or more components designed to transmit and/or receive information from one source to another. One or more of the elements of the vehicle 200 and/or one or more elements of the trailer 300 can include and/or execute suitable communication software, which enables the various elements to communicate with each other through the communication network and perform the functions disclosed herein.

The one or more communication networks can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

Now that the various potential systems, devices, elements and/or components of a balanced braking system have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

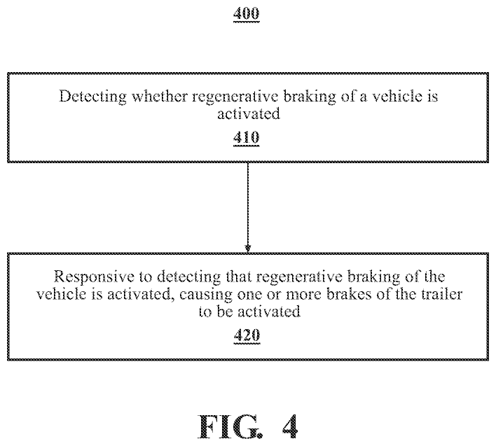

Turning to FIG. 4, an example of a method 400 is shown. At block 410, it can be detected whether regenerative braking of the vehicle 200 is activated. Such detection can be made by one or more of the sensors 220 (e.g., the regenerative braking sensor(s)), the processor(s) 210, and/or the trailer braking control module(s) 290. If it is detected that regenerative braking of the vehicle 200 is not activated, the method 400 can end, return to block 410, or proceed to some other block. However, if it is detected that regenerative braking of the vehicle 200 is activated, then the method can proceed to block 420.

At block 420, responsive to detecting that regenerative braking of the vehicle 200 is activated, one or more brakes 315 of the trailer 300 can be caused to be activated. Such causing can be performed by the processor(s) 210 and/or the trailer braking control module(s) 290. For instance, the processor(s) 210 and/or the trailer braking control module(s) 290 can cause the valve(s) 280 associated with the compressed air source(s) 270 to be opened. As a result, compressed air can flow to the braking system 310 and/or the brakes 315 of the trailer 300, causing the brakes of the trailer 300 to activate.

After block 420, the method 400 can end. Alternatively, the method 400 can return to block 410 or some other block. The method 400 can be performed continuously, periodically, irregularly, randomly, or responsive to a condition, event, or input.

One non-limiting example of the operation of the vehicle 200 and the trailer 300 in accordance with the above description will now be presented. A person can be driving the vehicle 200, which is towing the trailer 300. For purposes of this example, the brakes 255 of the vehicle 200 can be friction brakes.

At some point while driving, the person may release the accelerator pedal of the vehicle 200. As a result, the regenerative braking of the vehicle 200 can automatically be activated by the regenerative braking system 260. The regenerative braking system 260 can cause regenerative braking torque to be applied to at least some of the wheels 205 of the vehicle 200. For purposes of this example, the braking effectiveness of the vehicle 200 can have an arbitrary value of one (1) due entirely to the regenerative braking.

The activation of the regenerative braking of the vehicle 200 can be detected in any suitable manner. When the regenerative braking of the vehicle 200 is detected, the processor(s) 210 and/or the trailer braking control module(s) 290 can cause one or more brakes 315 of the trailer 300 to be activated. For instance, air from the compressed air source(s) 270 can be supplied to the braking system 310 of the trailer. The processor(s) 210 and/or the trailer braking control module(s) 290 can cause the one or more brakes 315 of the trailer 300 to be activated to a braking effectiveness that is substantially the same as the braking effectiveness of the vehicle 200. Thus, the braking effectiveness of the trailer 300 can be substantially one (1). Without arrangements described herein, the one or more brakes 315 of the trailer 300 would not be activated, thereby leading to a braking effectiveness differential between the vehicle 200 and the trailer 300. In such case, unwanted movements of the trailer 300 can occur.

If the driver reapplies the accelerator pedal, then the regenerative braking can stop. Thus, the braking effectiveness of the vehicle 200 can be zero (0). The cessation of the regenerative braking can be detected. In response, the processor(s) 210 and/or the trailer braking control module(s) 290 can cause one or more brakes 315 of the trailer 300 to be deactivated. Thus, the supply of air to the braking system 310 of the trailer 300 can be discontinued. As a result, the braking effectiveness of the trailer 300 can be zero (0), substantially the same as the braking effectiveness of the vehicle 200.

If, however, the driver instead engages the brake pedal while the accelerator pedal released, then friction braking can be applied to at least some of the wheels 205 of the vehicle 200. It should be noted that the regenerative braking also continues to be applied to at least some of the wheels 205 of the vehicle 200. At this point, the braking effectiveness of the vehicle 200 can have an arbitrary value of two (2): one (1) due to the regenerative braking plus one (1) due to the friction braking).

The additional friction braking can be detected. When it is, the processor(s) 210 and/or the trailer braking control module(s) 290 can cause the braking torque and/or braking effectiveness of the one or more brakes 315 of the trailer 300 to be increased. For instance, air from the compressed air source(s) 270 can be supplied to the braking system 310 at an increased amount and/or an increased pressure. The processor(s) 210 and/or the trailer braking control module(s) 290 can cause the one or more brakes 315 of the trailer 300 to be activated to a braking effectiveness that is substantially the same as the braking effectiveness of the vehicle 200. Thus, the braking effectiveness of the trailer 300 can be substantially two (2). Again, it will be appreciated that, without arrangements described herein, the contribution of the regenerative braking on the overall braking effectiveness of the vehicle 200 would not be considered with respect to the braking of the trailer 300, thereby leading to a braking effectiveness differential between the vehicle 200 and the trailer 300. In such case, unwanted movements of the trailer 300 can occur.

Thus, at all times, the contribution of regenerative braking on the overall braking effectiveness of the vehicle 200 is accounted for. Further, in the period of time in which the accelerator pedal is released but the brake pedal has not been engaged, arrangements described herein have already started to apply a level of braking to at least some of the wheels 305 of the trailer 300.

Continuing with the example, the driver may subsequently release the brake pedal. When this happens, then friction braking is no longer applied to at least some of the wheels 205 of the vehicle 200. Rather, only regenerative braking is applied. At this point, the braking effectiveness of the vehicle 200 can have an arbitrary value of one (1) due solely to regenerative braking.

The cessation of the friction braking can be detected. When it is, the processor(s) 210 and/or the trailer braking control module(s) 290 can cause the braking torque and/or braking effectiveness of the one or more brakes 315 of the trailer 300 to be decreased. For instance, air from the compressed air source(s) 270 can be supplied to the braking system 310 at a decreased amount and/or a decreased pressure. The processor(s) 210 and/or the trailer braking control module(s) 290 can cause the one or more brakes 315 of the trailer 300 to be activated to a braking effectiveness that is substantially the same as the braking effectiveness of the vehicle 200. Thus, the braking effectiveness of the trailer 300 can be substantially one (1).

The above process can continue until the driver engages the accelerator pedal or the vehicle comes to a stop. It should be noted that, in some arrangements, the regenerative braking system 260 can stop applying regenerative braking when the speed of the vehicle drops below a speed threshold (e.g., about 5 miles per hour (mph) or less, about 4 mph or less, about 3 mph or less, about 2 mph or less, or about 1 mph or less). In such case, there will not be a regenerative braking component to the overall braking effectiveness of the vehicle 200. Here, the braking effectiveness of the trailer 300 can be substantially one (1) due solely to friction braking. The processor(s) 210 and/or the trailer braking control module(s) 290 can cause the one or more brakes 315 of the trailer 300 to be activated to a braking effectiveness that is substantially the same as the braking effectiveness of the vehicle 200.

It will be appreciated that arrangements described herein can provide numerous benefits, including one or more of the benefits mentioned herein. For example, arrangements described herein can reduce or eliminate potential push force from a trailer to a powered vehicle towing the trailer. Arrangements described herein can prevent or reduce trailer sway or jackknifing. Arrangements described herein can provide a smoother driving experience. Arrangements described herein can improve driving safety. Arrangements described herein can be implemented without modification to the trailer.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope of the invention.

What is claimed is:

1. A method of balanced braking for a vehicle and a trailer, the method comprising:
detecting whether regenerative braking of the vehicle is activated; and
responsive to detecting that regenerative braking of the vehicle is activated, causing one or more brakes of the trailer to be activated.

2. The method of claim 1, wherein detecting whether regenerative braking of the vehicle is activated includes detecting that an accelerator pedal of the vehicle is not engaged.

3. The method of claim 1, wherein detecting whether regenerative braking of the vehicle is activated includes detecting regenerative braking torque applied to one or more wheels of the vehicle.

4. The method of claim 3, further including detecting an amount of regenerative braking torque applied to the one or more wheels of the vehicle.

5. The method of claim 4, wherein causing one or more brakes of the trailer to be activated includes causing one or more brakes of the trailer to be activated with an amount of braking torque that is substantially the same as the amount of regenerative braking torque applied to the one or more wheels of the vehicle.

6. The method of claim 1, wherein causing one or more brakes of the trailer to be activated includes causing one or more brakes of the trailer to be activated at an amount of braking torque that is substantially the same as an amount of regenerative braking of the vehicle.

7. The method of claim 1, wherein causing one or more brakes of the trailer to be activated includes causing a valve to be opened to allow compressed air from the vehicle to be supplied to the one or more brakes of the trailer.

8. The method of claim 1, further including:
detecting whether regenerative braking of the vehicle is no longer activated; and
responsive to detecting that regenerative braking of the vehicle is no longer activated, causing one or more brakes of the trailer to be deactivated or causing an amount of braking of one or more brakes of the trailer to be reduced.

9. The method of claim 8, wherein detecting whether regenerative braking of the vehicle is no longer activated includes detecting that a speed of the vehicle is below a speed threshold.

10. A system of balanced braking for a vehicle and a trailer, the system comprising:
one or more processors, the one or more processors being programmed to initiate executable operations comprising:
detecting whether regenerative braking of the vehicle is activated; and
responsive to detecting that regenerative braking of the vehicle is activated, causing one or more brakes of the trailer to be activated.

11. The system of claim 10, wherein the one or more processors are located onboard the vehicle.

12. The system of claim 11, wherein the vehicle is an electric vehicle.

13. The system of claim 10, further including a compressed air source, wherein the compressed air source is located onboard the vehicle.

14. The system of claim 13, wherein the compressed air source is a compressor.

15. The system of claim 13, further including a conduit operatively connected to the compressed air source, wherein the conduit is in fluid communication to supply compressed air from the compressed air source to the one or more brakes of the trailer.

16. The system of claim 15, further including a valve operatively positioned along the conduit to control the supply compressed air from the compressed air source to the one or more brakes of the trailer, and wherein causing one or more brakes of the trailer to be activated includes causing the valve to be opened to allow compressed air from the compressed air source to be supplied to the one or more brakes of the trailer.

17. The system of claim 10, further including one or more sensors configured to acquire data about an amount of regenerative braking torque applied to one or more wheels of the vehicle, and wherein the one or more sensors are operatively connected to the processors.

18. The system of claim 17, wherein causing one or more brakes of the trailer to be activated includes causing one or more brakes of the trailer to be activated in an amount of braking torque that is substantially the same as the amount of regenerative braking torque applied to the one or more wheels of the vehicle.

19. The system of claim 10, further including one or more sensors configured to acquire data about whether or not an accelerator pedal of the vehicle is engaged, wherein the one or more sensors are operatively connected to the processors, and wherein detecting whether regenerative braking of the vehicle is activated includes detecting that the accelerator pedal of the vehicle is not engaged.

20. The system of claim 10, wherein the executable operations further include:
detecting whether regenerative braking of the vehicle is no longer activated; and
responsive to detecting that regenerative braking of the vehicle is no longer activated, causing one or more brakes of the trailer to be deactivated or causing an amount of braking of one or more brakes of the trailer to be reduced.
